(19) United States
(12) Patent Application Publication
(10) Pub. No.: US 2010/0023713 A1
(43) Pub. Date: Jan. 28, 2010

(54) Archive system and contents management method

(75) Inventors: Hiroshi Nasu, Yokohama (JP); Masayuki Yamamoto, Sagamihara (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/230,903

(22) Filed: Sep. 8, 2008

(30) Foreign Application Priority Data
Jul. 24, 2008 (JP) 2008-190541

(51) Int. Cl. G06F 12/02

(52) U.S. Cl. 711/161; 711/E12.002

(57) ABSTRACT

There is provided an archive system that performs processing on arbitrary contents, the system including a grouping section that groups multiple archive nodes included in a cluster, a policy section that defines a requirement for performing processing on the arbitrary contents, and a control section that determines a group for performing processing on the arbitrary contents based on the group information about the definition of the grouping of the multiple archive nodes and the requirement and controls the determined group to perform the processing.

### BACKGROUND OF THE INVENTION

1. Field of the Invention

The present invention relates to an archive system including a computer and a storage device. In particular, it relates to a technology for managing archive data in consideration of a system configuration.

2. Description of the Related Art

Generally, an archive system includes a host computer that performs an operation and an archive node from or to which data is read or written according to an instruction from the host computer. Here, the term “archive” refers to a part that is responsible for long-term storage of data.

Here, Patent Document 1 discloses a distributed archive technology including a cluster having multiple archive nodes, wherein archive data is written to multiple archive nodes based on the data redundancy designated by the host computer so that the host computer can access the archive data even in a case where a part of the archive nodes has a failure.

In the distributed archive technology, each archive node performs contents management processing on arbitrary contents (or files). Specifically, the contents management processing includes contents copy, contents deduplication, contents search and creation of an index for search.

The contents copy processing is processing in which an arbitrary node copies contents stored in the archive node to another archive node. Making the contents redundant between or among archive nodes, the access to the contents is assured even when one of the arbitrary archive nodes has a failure.

The contents deduplication processing is processing in which a representative arbitrary archive node consolidates and stores overlapping contents into its own arbitrary archive node, and makes a link such that other archive nodes can access to the contents stored in the arbitrary archive node, which prevents the storage of the entity of contents in other archive nodes. By consolidating contents between or among archive nodes, the amount of contents of archive data can be reduced.

In the contents search processing, an arbitrary archive node creates an index such that arbitrary contents can be searched from contents stored in all archive nodes.

According to the policy defined by a user or a manager, each archive node performs contents management processing. The term, “policy”, here refers to a requirement defined for performing processing including the necessity for contents management processing and/or the range of the processing. For example, when a user or a manager defines a redundancy “2” as the policy in the contents copy processing, contents stored in an arbitrary archive node is copied and stored to another archive node. In other words, same contents are stored in two archive nodes. When a user or a manager defines the policy “executable” in the contents deduplication processing, an arbitrary archive node performs the deduplication processing. Then, when a user or a manager defines the policy “executable” in the contents search processing, an arbitrary archive node searches arbitrary contents.

Patent Document 1: US 2005/0120025 A1, Specification Applying the distributed archive technology under the environment in which multiple archive nodes in one archive system are scattered over two or more remote sites causes problems as follows:

It is assumed that an arbitrary archive node performs the contents copy processing so that contents and copied contents can be stored in two archive nodes on a same site. If the site has a disaster or a system failure in this case, there is a possibility that a host computer may not access both of the contents and the copied contents or a possibility that both of the contents and the copied contents are lost.

It is assumed that the deduplication processing on contents performed by an arbitrary archive node allows a site to have a representative archive node that stores contents and allows different remote sites to have a different archive node that have a link to the contents. In this case, in order for a host computer to access the contents held by the different archive node, the different archive node must issue an access request for the contents to the representative archive node on the different site, which may reduce the access performance.

Since the processing of searching contents by an arbitrary archive node must search a wider range of contents, the searching performance may be reduced.

Although archive nodes in one archive system are scattered over two or more remote sites, each archive node cannot grasp the sites and the archive nodes on the sites to perform contents management processing.

### SUMMARY OF THE INVENTION

Accordingly, it is an object of the invention to provide an archive system and a contents management method in consideration of the locations of archive nodes and contents management.

According to an aspect of the invention, in order to achieve the object, there is provided an archive system that performs processing on arbitrary contents, the system including a grouping section that groups multiple archive nodes in a cluster, a policy section that defines a requirement for performing processing on the arbitrary contents, and a control section that determines a group for performing processing on the arbitrary contents based on the group information about the definition of the grouping of the multiple archive nodes and the requirement and controls the determined group to perform the processing.

As a result, an archive node can be located, and predetermined processing can be performed on arbitrary contents even under an environment in which archive nodes included in one archive system are scattered over two or more remote sites.

According to another aspect of the invention, there is a contents management method in an archive system that performs processing on arbitrary contents, the method including a first step of grouping multiple archive nodes in a cluster, a second step of defining a requirement for performing processing on the arbitrary contents, and a third step of determining a group for performing processing on the arbitrary contents based on the group information about the definition of the grouping of the multiple archive nodes and the requirement and controlling to perform the processing by the determined group.

As a result, an archive node can be located, and predetermined processing can be performed on arbitrary contents even under an environment in which archive nodes included in one archive system are scattered over two or more remote sites.

Contents management processing can be performed by recognizing the site and locating the archive nodes on the site by each archive node even under an environment in which archive nodes included in one archive system are scattered over two or more remote sites.

### BRIEF DESCRIPTION OF THE DRAWINGS

FIG. 1 is a block diagram showing a configuration of an archive system according to an embodiment of the invention;

FIG. 2 is a block diagram showing a configuration of a host computer according to the embodiment;

FIG. 3 is a block diagram showing a configuration of an archive node according to the embodiment;

FIG. 4 is a block diagram showing a configuration of a storage device according to the embodiment;

FIG. 5 is a block diagram showing a configuration of a management computer according to the embodiment;

FIG. 6 is a diagram showing a contents management schedule table according to the embodiment;

FIG. 7 is a diagram showing a mapping management table according to the embodiment;

FIG. 8 is a diagram showing an index management table according to the embodiment;

FIG. 9 is a diagram showing a group management table according to the embodiment;

FIG. 10 is a diagram showing a policy management table according to the embodiment;

FIG. 11 is a flowchart illustrating creation/update processing on the group management table according to the embodiment;

FIG. 12 is a flowchart illustrating archive processing and policy setting processing according to the embodiment;

FIG. 13 is a flowchart illustrating the archive processing and policy setting processing according to the embodiment;

FIG. 14 is a flowchart showing contents management processing according to the embodiment;

FIG. 15 is a flowchart showing copy processing according to the embodiment;

FIG. 16 is a flowchart illustrating deduplication processing according to the embodiment;

FIG. 17 is a flowchart illustrating index creating processing according to the embodiment; and

FIG. 18 is a flowchart illustrating search processing according to the embodiment.

### DESCRIPTION OF THE PREFERRED EMBODIMENTS

With reference to drawings, embodiments of the invention will be described below. It should be noted that the invention is not limited by the following descriptions.

### [1] Archive System of Embodiment of the Invention

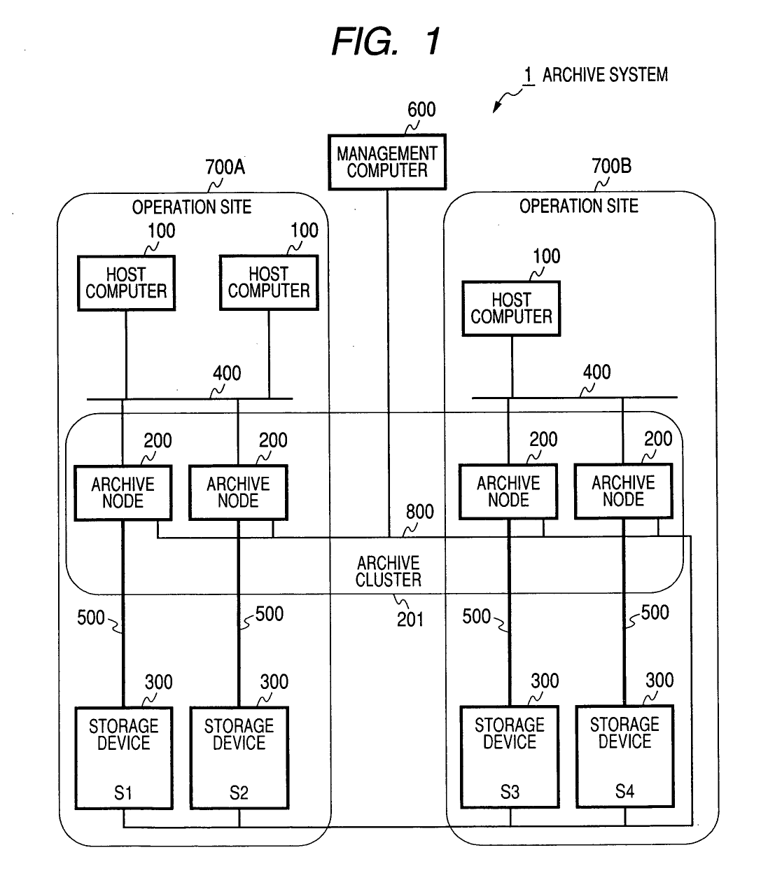

FIG. 1 is an example showing a configuration of an archive system of an embodiment of the invention.

On each of remote operation sites 700A and 700B in an archive system 1, a host computer 100 connects to an archive node 200 over a LAN (or Local Area Network) 400, and the archive node 200 connects to a storage device 300 over a SAN (or Storage Area Network) 500. Then, the multiple remote archive nodes 200 are included in one archive cluster 201. The archive nodes 200, storage devices 300 and a management computer 600 are mutually connected over a management network 800.

Having described that the networks 400, 500 and 800 adopt different kinds of network according to this embodiment, a same kind of network may be used. Two sites will be described as examples of the operation sites, and the archive system may include three or more operation sites.

Except for the case where operation sites are discriminated for description, the reference letters A and B are not given in the description below.

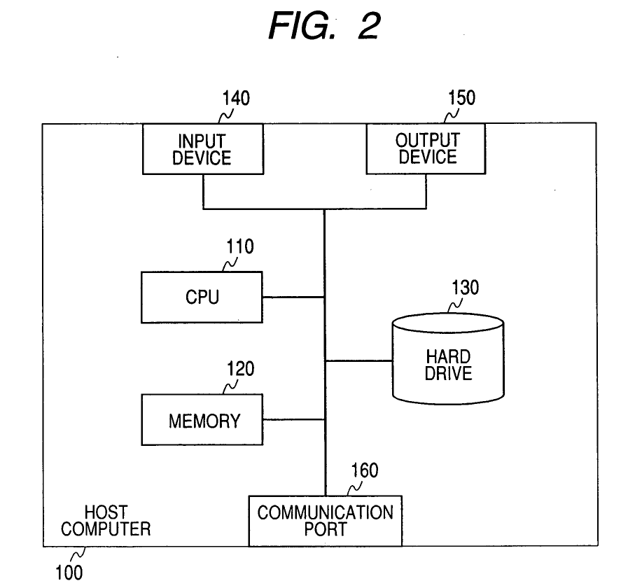

FIG. 2 is a configuration example of the host computer 100. The host computer 100 includes a CPU (or Central Processing Unit) 110, a memory 120 that stores data, a hard drive 130 that stores data, an input device 140 including a keyboard, an output device 150 including a screen and a communication port 160 that performs data communication with the archive node 200. The hardware configuration of the host computer 100 can be implemented by a generic electronic computer or an information processor (or personal computer) for example.

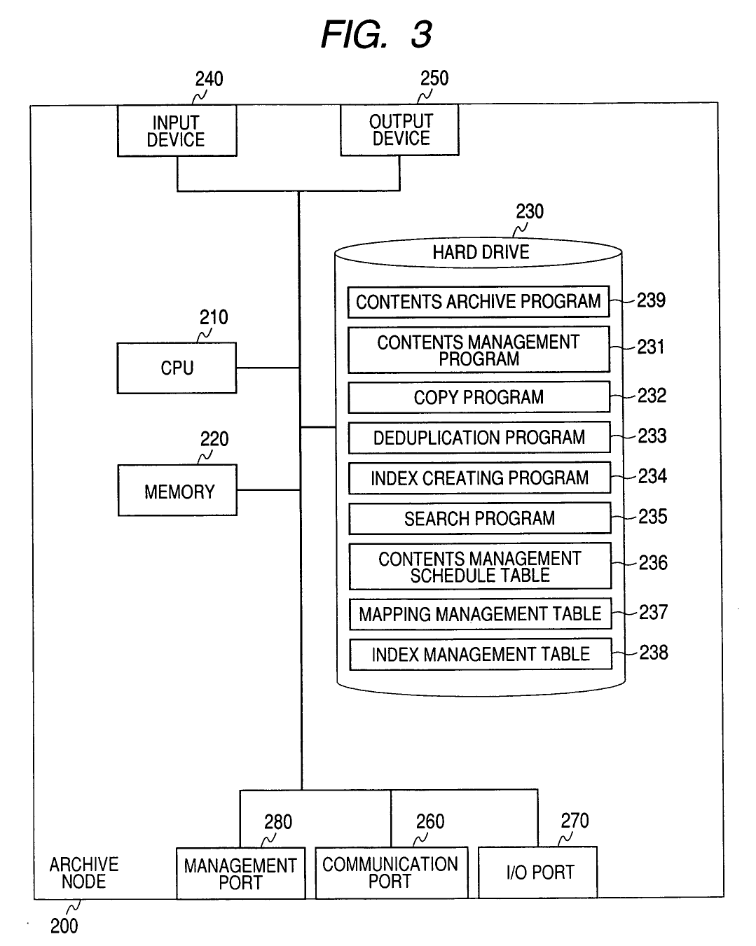

FIG. 3 is an example showing a configuration of the archive node 200. The archive node 200 includes a CPU 210, a memory 220, a hard drive 230, an input device 240, an output device 250, a communication port 260 that communicates data with the host computer 100 over the LAN 400, an IO (or Input/Output) port 270 that communicates data with the storage device 300 over the SAN 500 and a management port 280 that communicates data with other archive nodes 200, storage devices 300 and the management computer 600 over the management network.

The hard drive 230 includes a contents archive program 239, a contents management program 231, a copy program 232, a deduplication program 233, an index creating program 234, a search program 235, a contents management schedule table 236, a mapping management table 237 and an index management table 238.

The contents archive program 239 determines the archive node 200 for saving contents requested to store from the host computer 100 and registers a policy (which is an argument) for performing contents management processing. The expression, “contents management processing” refers to processing to be performed for saving contents as archive data for long period of time and includes contents copy processing, contents deduplication processing and search processing including processing of creating an index required for searching contents according to this embodiment. The term, “policy”, refers to a requirement defined for performing management processing and may include a registered redundancy and/or local processing within an operation area or global processing beyond an operation area.

The contents management program 231 manages such that the contents management processing can be performed normally.

The copy program 232 performs contents copy processing, and the deduplication program 233 performs contents deduplication processing.

The index creating program 234 creates an index required for searching contents.

The search program 235 searches contents in response to a contents search request transmitted from the host computer 200 and transmits the search result to the host computer 200.

The tables 236, 237 and 238 will be described later.

The hardware configuration of the archive node 200 can be implemented by a generic electronic computer or an information processor (or personal computer), for example.

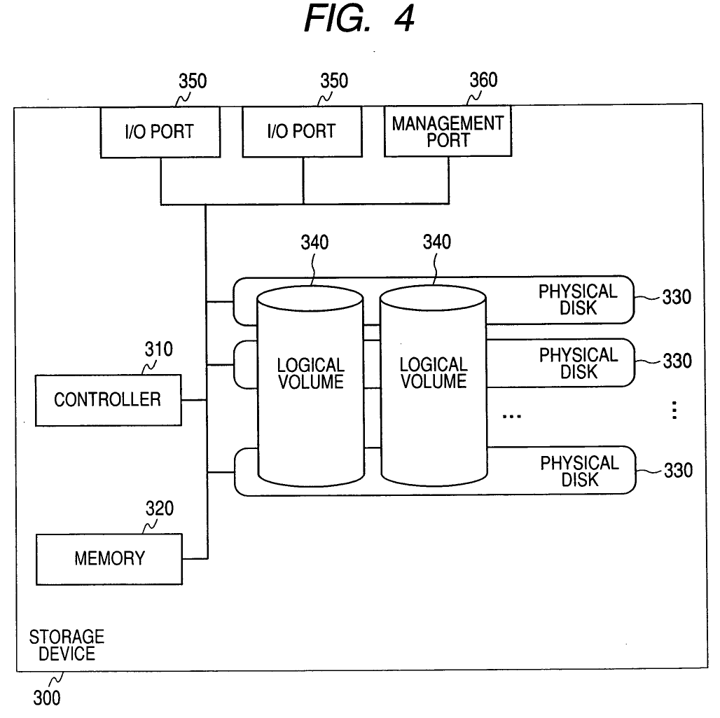

FIG. 4 is an example showing a configuration of the storage device 300. The storage device 300 includes a controller 310 that controls the storage device 300, a memory 320, an IO port 350 to be used for communication with the archive node 200 of the archive cluster 201, a management port 360 to be used for communication with the archive node 200 or management computer 600 and one or more physical disks 330.

The storage device 300 divides a storage area of the one or more physical disks 330 and manages the divided storage areas as logical volumes 340. The storage device 300 provides multiple logical volumes 340 to the archive node 200. The logical volume 340 includes multiple segments and assigns a storage area on the physical disk 330 to each segment so that an IO request (such as a write request and read request) from the host computer 100 to the logical volume 340 can be received and the requested contents can be exchanged.

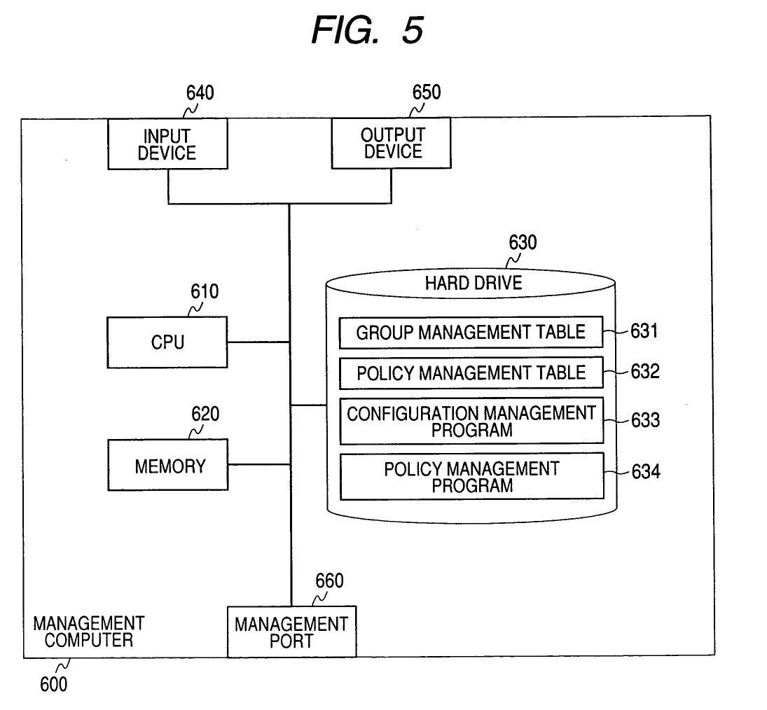

FIG. 5 is an example showing a configuration of the management computer 600. The management computer 600 includes a CPU 610, a memory 620, a hard drive 630, an input device 640, an output device 650 and a management port 660 to be used for communication with the archive node 200 or storage device 300.

The hard drive 630 internally contains a configuration management program 633 that detects the layout of the archive nodes 200, the layout of the storage devices 300 and mutual connection relationships upon installation of the system or addition or reduction of the archive node or nodes 200 or storage device devices 300, a group management table 631 that manages system configuration information detected by the configuration management program 633, a policy management table 632 that manages policy information for performing contents management processing and a policy management program 634 that exchanges policy information and updates the policy management table 632.

Notably, the hardware configuration of the management computer 600 can be implemented by a generic electronic computer or an information processor (or personal computer) for example.

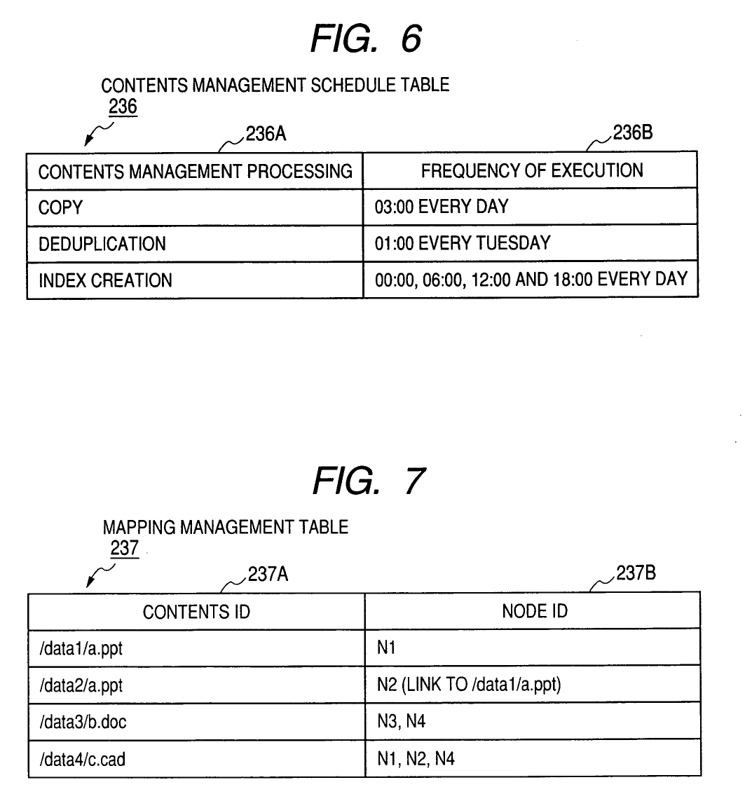

FIG. 6 is an example showing the contents management schedule table 236.

The contents management schedule table 236 manages the schedule for performing contents management processing.

The contents management schedule table 236 includes a “Contents Management Processing” column 236A for identifying contents management processing and a “Frequencies of Execution” column 236B for identifying the schedule of contents management processing.

For example, the contents management schedule table 236 in FIG. 6 shows that copy processing on contents (or archive data) of the contents management processing is to be performed at 3:00 everyday. Similarly, the contents management schedule table 236 shows that the deduplication processing is to be performed at 1:00 every Tuesday and that the index creating processing is to be performed at 2:00 everyday.

According to this embodiment, the archive node 200 performs processing on all connected archive data with the frequency of execution on the contents management schedule table 236. However, processing may be performed with the frequency of execution registered for each archive data.

FIG. 7 is a configuration example of the mapping management table 237.

The mapping management table 237 manages the mapping between contents and the archive node 200 that saves the contents.

The mapping management processing table 237 includes a “Contents ID” column 237A that identifies contents, which is archive data, and a “node ID” column 237B that identifies the archive node 200 that saves the contents.

For example, in a case where same contents are consolidated to the representative archive node 200 by performing the deduplication processing by the archive node 200, a link is established between the “Node ID” column 237B and the contents, which is an entity of a different contents ID, and a note such as “(Link to N1)” may be added.

Methods for determining contents with different contents IDs as same contents may include a method that determines the identity by comparing the data of contents. Referring to the contents IDs shown in FIG. 7, if the contents with different IDs “/data1/a.ppt” and “data2/a.ppt” have same data, the archive node 200 determines that they are the same contents. The determination method is only an example, and the determination method is not limited to the aforesaid method.

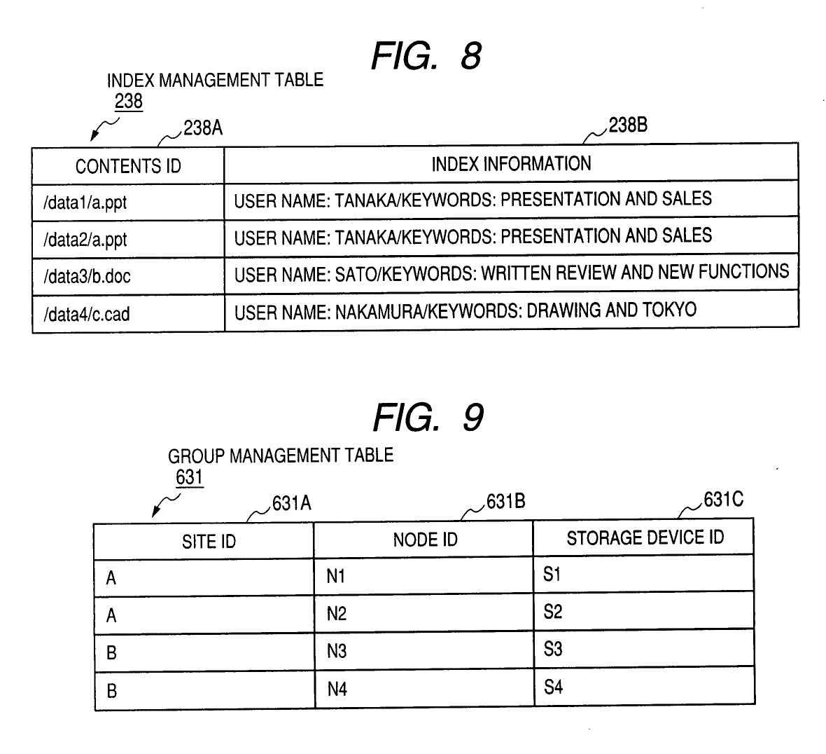

FIG. 8 is an example showing an index management table 238.

The index management table 238 manages index information for searching arbitrary contents.

The index management table 238 includes a “Contents ID” column 238A for identifying contents and an “Index Information” column 238B for managing index information. The index information may be information for identifying arbitrary contents. The index management table 238 shown in FIG. 8 includes attribute information such as the name of a user who creates contents and the date of the creation and index information such as a keyword in the data of contents.

In the example in FIG. 8, the index information for searching contents with the ID “/data4/c.cad” is “Nakamura”, “Drawing” or “Tokyo”.

FIG. 9 is an example showing the group management table 631.

The group management table 631 manages the correspondence relationship among an operation site 700, an archive node 200 and a storage device 300. The group management table 631 groups the archive nodes 200 on a same operation site 700 or the archive nodes 200 sharing one same storage device 300.

The group management table 631 includes a “Site ID” column 631A that identifies an operation site 700, a “Node ID” column 631B that identifies the archive node 200 present within the operation site 700 and a “Storage Device ID” column 631C that identifies a storage device 300 connecting to the archive node 200.

In the example in FIG. 9, archive nodes and storage devices are grouped for each of operation sites 700A and 700B. The archive nodes 200 sharing one same storage device 300 may be grouped.

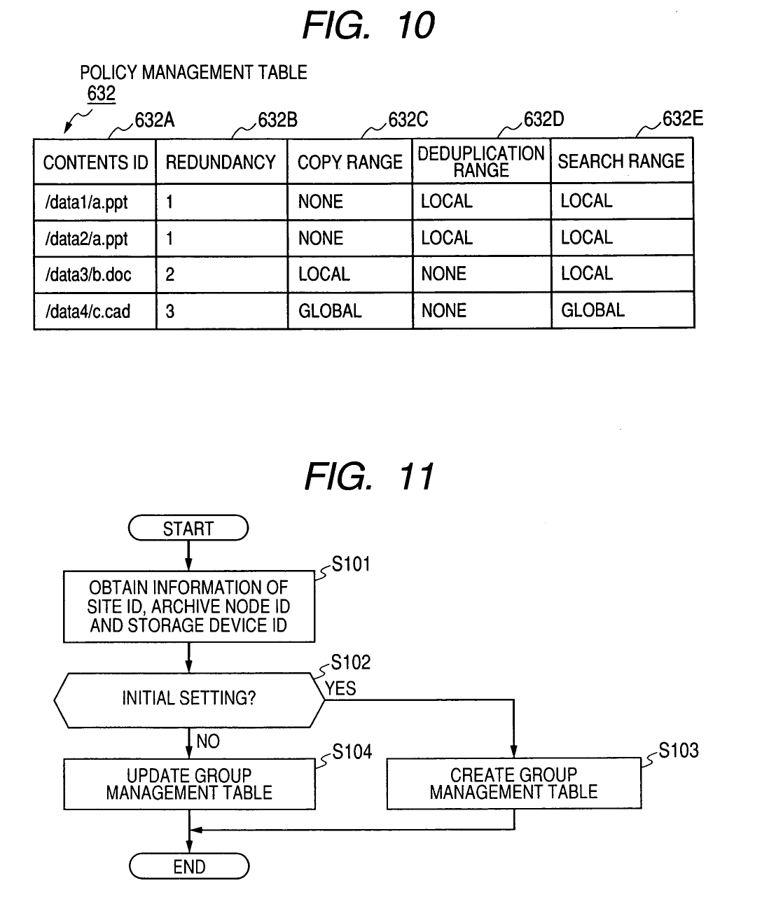

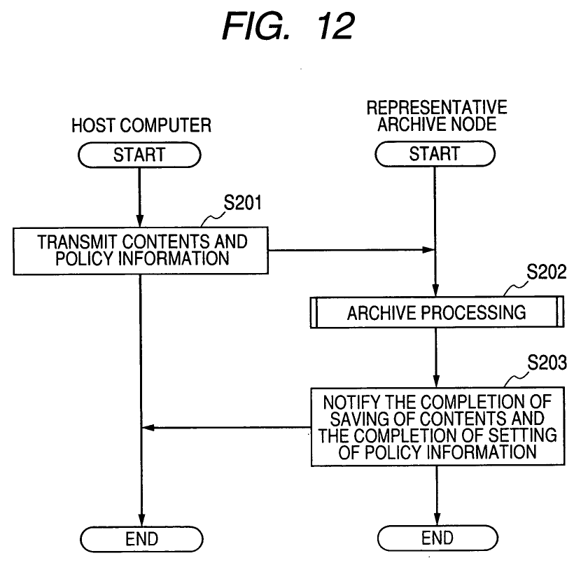

FIG. 10 is an example showing the policy management table 632.

The policy management table 632 manages a requirement for a case where contents management processing is to be performed on arbitrary contents.

The policy management table 632 includes a “Contents ID” column 632A that identifies contents, a “Redundancy” column 632B indicates the redundancy of contents, a “Copy Range” column 632C that describes the copy range of contents, a “Deduplication Range” column 632D that describes the deduplication range of contents and a “Search Range” column 632E that describes the valid range for searching contents.

The “Redundancy” column 632B has the required number of copies of contents. For example, a redundancy “1” means that the original contents is only required. A redundancy“2” means that two copies of contents are required.

Therefore, the setting of the “copy range” depends on the number in the “Redundancy”. If the redundancy “1” is set, “the “Copy Range” column 632C has the setting of “None” (or no copy). If the redundancy “2” or more is set, the “Copy Range” column 632C has “Local” (which means the saving of a copy within the same site as that of the original contents) or “Global” (which means the saving of a copy to a different site from that of the original contents).

The “Deduplication Range” column 632D has the setting of “None” (no deduplication), “Local” (which means that deduplication processing within one same site is performed on overlapping contents in the range of the site) or “Global” (which means that deduplication processing not only in one site but also in other sites is performed on overlapping contents in the range of all sites where the contents exist).

The “Search Range” column 632E has the setting of “None” (which means that index information for searching contents is not created and is excluded from the search subject), “Local” (which means that index information of contents is used only within a site) or “Global” (which means that index information of contents is shared all sites).

The archive system 1 according to this embodiment performs (A) detection of the layout and connection relationship of archive nodes, (B) setting of the policy and (C) contents management processing.

### (A) Detection of the Layout and Connection Relationship of Archive Nodes

The management computer 600 (or possibly a representative archive node 200) that centrally manages the layouts of the archive nodes 200 and the storage devices 300 detects the layout and connection relationship of archive nodes 200 upon installation of the system, upon addition or reduction of the archive nodes 200 or upon addition or reduction of the storage devices 300. As a result of the detection, the management computer 600 groups the archive nodes 200 on a same operation site 700 or the archive nodes 200 sharing one storage device 300 and registers them to the group management table 631. The group management table 631 is shared among the management computer 600 and the archive nodes 200.

### (B) Setting of Policy

Upon saving of arbitrary contents to the storage device 300, a system manager may set the policy for performing contents management processing (or processing of copy, deduplication or index creation for search) by using group information. The setting result is registered with the policy management table 632. The policy management table 632 is shared among the management computer 600 and the archive nodes 200.

### (C) Contents Management Processing

In order to perform contents management processing (which may be processing of copy, deduplication or index creation for search), each of the archive nodes 200 determines either within the group of the operation area 700 (that is, Local) or across multiple groups (beyond one operation area 700) (that is, Global) with reference to the policy management table 632. In order to perform processing across multiple groups by each of the archive nodes 200, the archive node 200 requests processing of copy, deduplication or index creation for search to a different archive node from the archive node with reference to the group management table 631.

The processing routines to be implemented by (A) to (C) will be described.

First of all, the routine of creating or updating the group management table 631 will be described with reference to the flowchart shown in FIG. 11.

The processing of creating or updating the group management table 631 is performed by the CPU 610 of the management computer 600 based on the configuration management program 633. The processing is performed upon installation of the system, addition or reduction of the archive nodes 200 or addition or reduction of the storage devices.

First of all, for each operation site 700, the CPU 610 obtains the physical positional information on the archive nodes 200 and storage devices 300 and configuration information connecting the archive node 200 and the storage device 300 over the management network 800 (S101).

In order to initialize the group management table 631 (S102: YES), the CPU 610 registers site IDs, archive node IDs and storage device IDs based on the obtained physical positional information and configuration information (S103) and exits the processing.

In order not to initialize the group management table 631 on the other hand, the CPU 610 updates the site IDs, archive node IDs and storage device IDs based on the obtained physical positional information and configuration information (S104) and exits the processing.

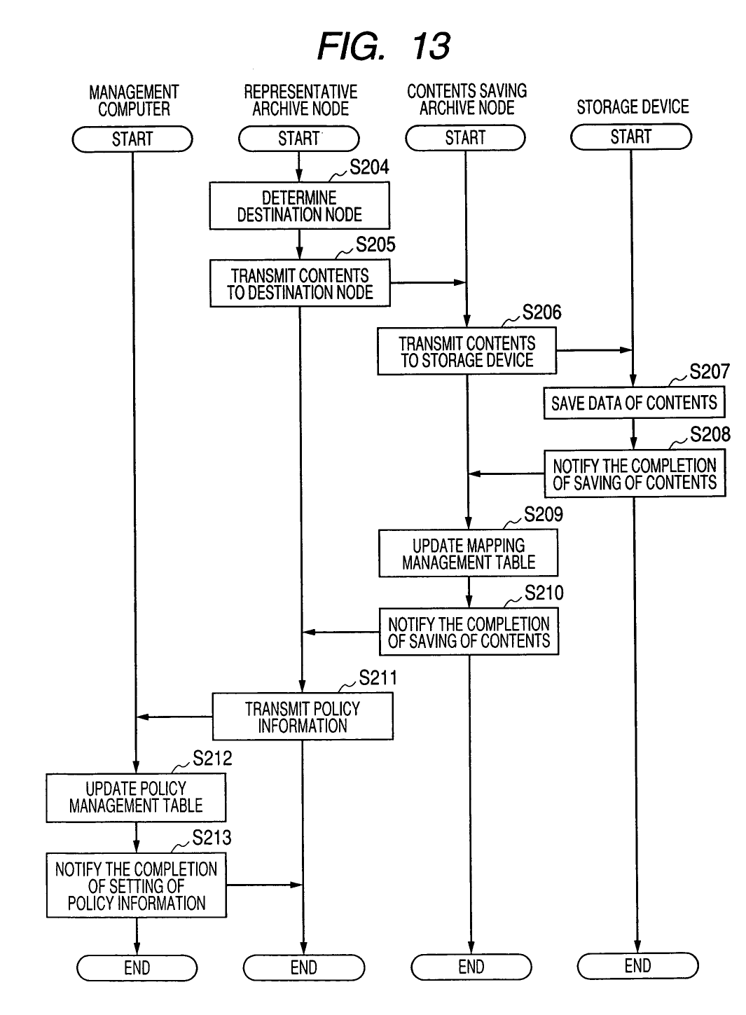

Next, a processing routine for creating the mapping management table 237 and policy management table 634 in the implementation of archive processing for saving contents in a storage device and policy setting processing on contents will be described with reference to the flowcharts shown in FIGS. 12 and 13.

The archive processing and policy setting processing are performed by the CPU 210 of a representative archive node 200 (which will be simply called representative CPU 210) based on the contents archive program 239 and are performed by the CPU 610 of the management computer 600 based on the policy management program 634.

First of all, the CPU 110 of the host computer 100 transmits a contents desired to save for a long period of time and policy information to be defined for the contents to the representative archive node 200 within an operation site 700 (S201)

The representative CPU 210 having received the contents and policy information performs the archive processing on the contents (S202). The contents archive processing will be described later.

The representative CPU 210 performs the archive processing to complete the saving of the contents and the setting of the policy information and then notifies the fact of the completion to the host computer 100 (S203) and exits the processing.

Next, details of contents archive processing in step S202 in FIG. 12 will be described.

The representative CPU 210 determines the destination archive node 200 to save the contents (which will be called destination node 200) (S204). The destination node 200 may be determined at random or may be the archive node 200 having a minimum amount of saved data or may be determined by any other methods.

Next, the representative CPU 210 transmits the contents from the host computer 100 to the destination node 200 determined by step S204 (S205).

The CPU 210 of the destination node 200 having received the contents transmits the received contents to the storage device 300 connecting to the own node (S206).

The controller 310 of the storage device 300 having received the contents saves the data of the contents to a representative logical volume 340 (S207). Then, the controller 310 notifies the destination node 200 of that the data of the contents has been saved (S208).

The CPU 210 of the destination node 200 having received the notification updates the mapping management table 237 (S209). The CPU 210 of the destination node 200 registers its own node ID and the contents ID with the mapping management table 237.

Then, the CPU 210 of the destination node 200 notifies the representative archive node 200 of that the saving of the data of the contents has completed (S210).

The representative CPU 210 having received the notification of the completion of the saving of the data of the contents transmits the policy information from the host computer 100 to the management computer 600 (S211).

The CPU 610 of the management computer 600 registers the received policy information with the policy management table 632 (S212), then notifies the representative archive node 200 of the completion of the setting of the policy information (S213) and exits the processing.

After that, the representative archive node 200 having received the notification of the completion of the setting of the policy information from the management computer 600 notifies the host computer 100 of the completion of the saving of the contents and the completion of the setting of the policy information (S203).

Thus, the contents is saved in the storage device 300 connecting to the destination node 200 and is reflected to the mapping management table 237, and the policy information on the contents is registered with the policy management table 632.

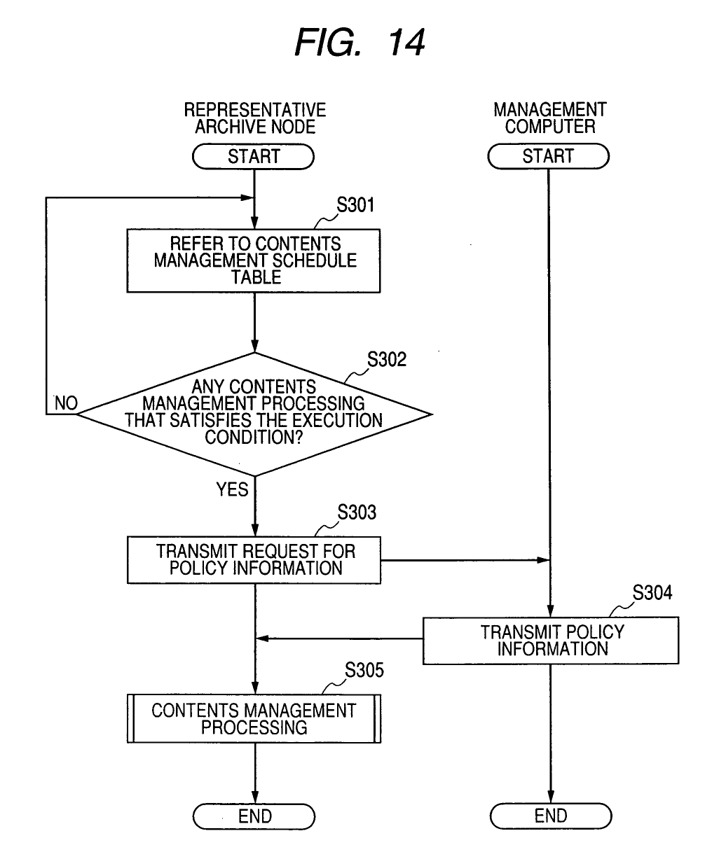

Next, the routine for contents management processing to be performed by each of the archive nodes 200 will be described with reference to the flowchart shown in FIG. 14. The management processing is performed by the representative CPU 210 based on the contents management program 231 and by the CPU 610 of the management computer 600 based on the policy management program 634.

First of all, the representative CPU 210 refers to the contents management schedule table 236 periodically (S301) and checks whether any contents management processing that satisfies a requirement for execution exists or not (S302). If some contents management processing that satisfies the requirement for execution exists (S302: YES), the representative CPU 210 refers to the mapping management table 237 and transmits the management computer 600 the request for the policy information on all contents, which are subjects of the management processing by the own archive node 200 (S303).

The CPU 610 of the management computer 600 having received the request for the policy information refers to the policy management table 632 and transmits the policy information of all contents, which are subjects of the management processing by the representative archive node 200 (S304).

The representative CPU 210 having received the policy information of all contents performs actual contents management processing based on the contents management schedule table 236 and the policy information (S305) and exits the processing.

The representative CPU 210 requests the management computer 600 the policy information on the contents, which are subjects of the management processing by the representative CPU 210, according to this embodiment. However, the policy management table 632 may be requested.

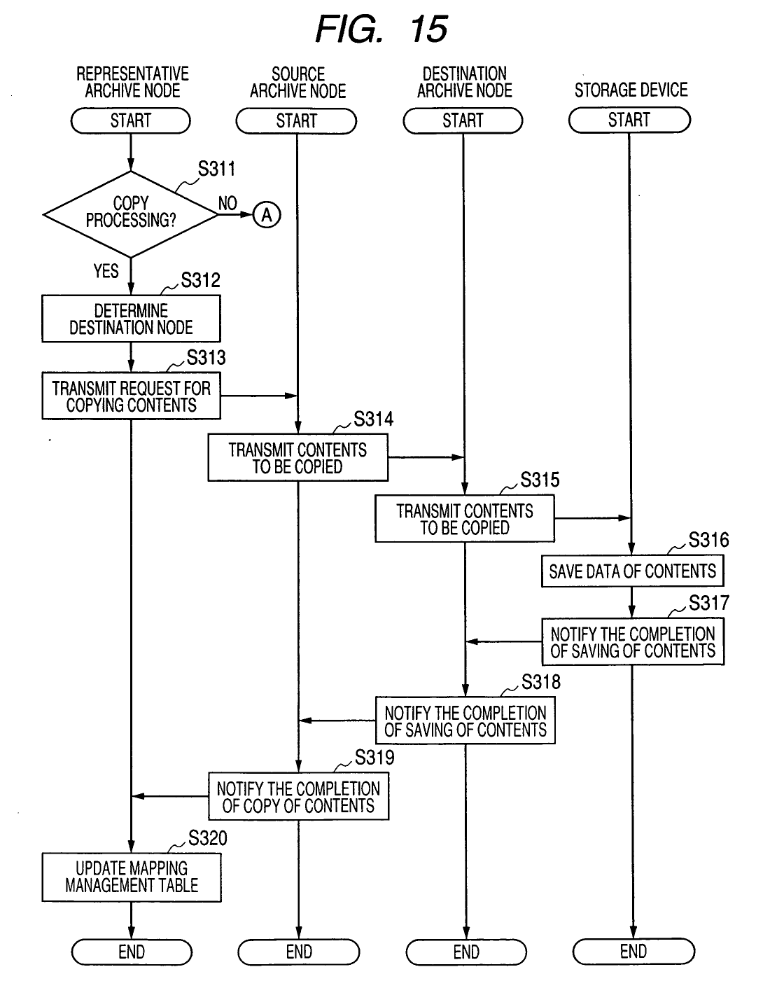

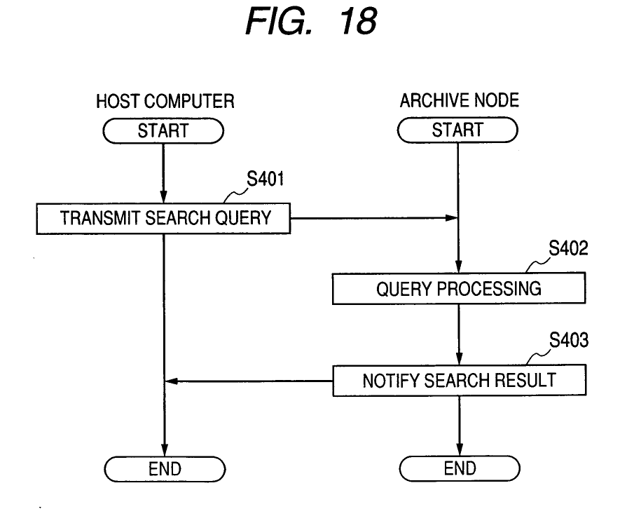

With reference to the flowcharts shown in FIGS. 15 to 18, a more specific routine of the contents management processing in step S305 will be described.

If the contents management processing that satisfies a requirement for execution is the copy processing on contents (S311: YES), the representative CPU 210 performs contents copy processing shown in FIG. 15. The contents copy processing is performed by the representative CPU 210 based on the copy program 232. The case where the contents management processing is not contents copy processing (S311: NO) will be described later.

First of all, the representative CPU 210 determines the source archive node and the destination archive node from the policy information transmitted in step S304 (S312). The representative CPU 210 refers to the mapping management table 237 and determines the archive node 200 that holds contents to be the subject of the management processing as the source archive node. The source archive node may be determined at random or may be the archive node 200 having a minimum amount of saved data or may be determined by any other methods. For example, if the copy range in the policy information on the contents to be copied is “Local” and the redundancy is “2”, the source archive node is selected from the archive nodes 200 in the same operation area. On the other hand, if the copy range in the policy information on the contents to be copied is “Global” and the redundancy is “3”, the source archive node is selected from the archive nodes 200 not only in the same operation area but also in a different operation area. For the redundancy “3”, two destination archive nodes are required. Therefore, one archive node 200 may be selected in each of the same operation area and the different operation area. Alternatively, two archive nodes 200 may be selected in a different operation area.

The representative CPU 210 transmits a request for copying the contents to the determined source archive node 200 (S313)

The CPU 210 of the source archive node 200 (which will be simply called source CPU 210) having received the request for copying the contents transmits the contents to be copied to the selected destination archive node 200 (S314).

The CPU 210 of the destination archive node 200 (which will be simply called destination CPU 210) having received the request for copying the contents transmits the contents to be copied to the storage device 300 connecting to the destination archive node 200 (S315). The storage device 300 having received the contents to be copied saves the data of the contents to a logical volume 340 (S316) and notifies the completion of the saving of the contents to the destination archive node 200 (S317).

The destination CPU 210 having received the notification of the completion of the saving of the contents notifies the source archive node 200 of the contents ID, its own node ID and the completion of the saving of the contents (S318).

The source CPU 210 having received the notification of completion transmits the representative archive node 200 the copied contents ID, the destination node ID and the notification that the copy of the contents has completed (S319).

The representative archive node 200 having received the notification registers the copied contents ID and the destination node ID with the mapping management table 237 (S320) and then exits the copy processing (S305).

Thus, the archive system 1 can create a copy of contents based on the redundancy and copy range registered with the policy management table 632.

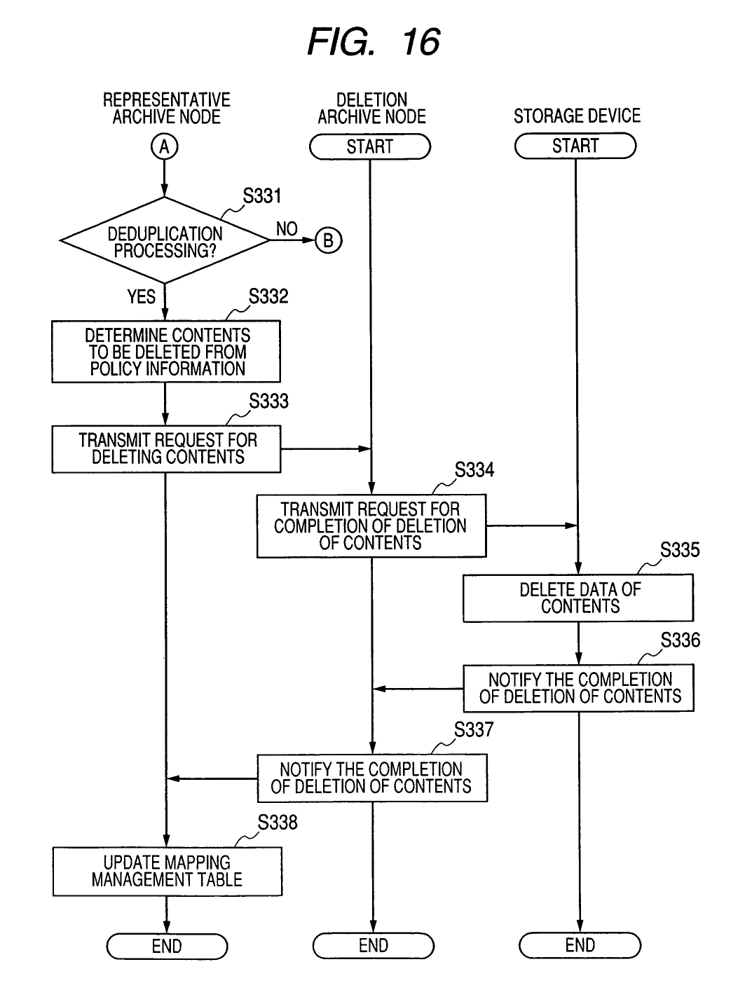

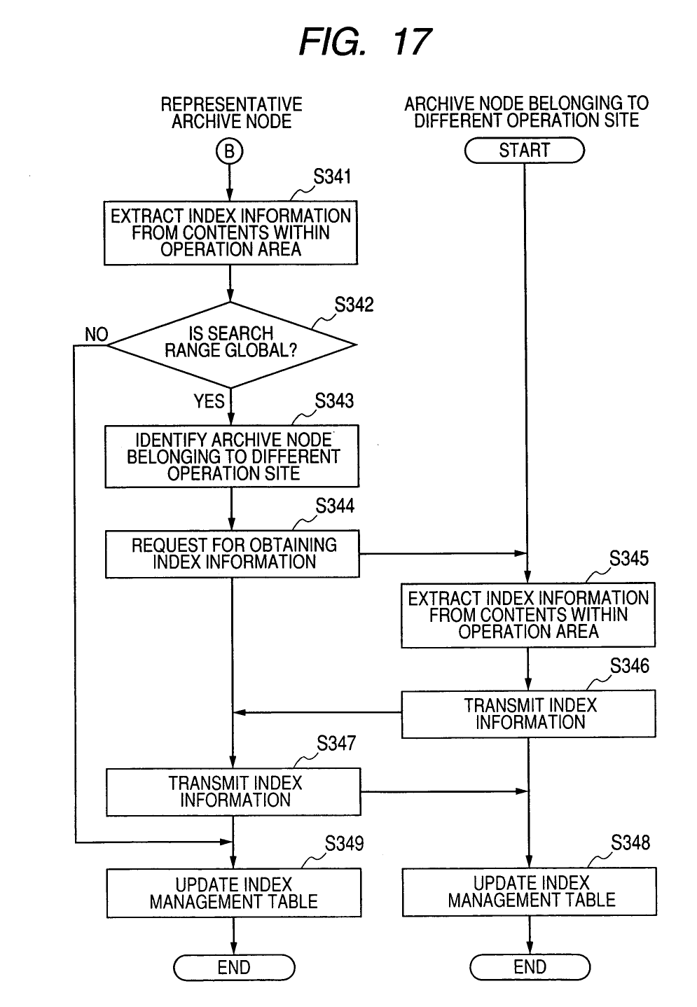

Next, the case (S311: NO) where the contents management processing is not contents copy processing in step S311 will be described. If the contents management processing that satisfies a requirement for execution is contents deduplication processing (S331: YES), the representative CPU 210 performs the contents deduplication processing shown in FIG. 16. The contents deduplication processing is performed by the representative CPU 210 based on the deduplication program 233. The case (S331:NO) where the contents management processing is processing of creating an index for search will be described later.

First of all, the representative CPU 210 determines the contents to be deleted based on the policy information (S332).

The method for determining the contents to be deleted may include comparing contents to determine whether they are identical or not, leaving arbitrary contents as representative contents from multiple contents and determining the other contents as contents to be deleted. The representative contents may be determined at random or may be contents held by the archive node 200 in the same operation area 700 as that of the representative archive node 200. The determination method may be selected arbitrarily. The comparison range is a range defined as the deduplication range in the policy information. If the deduplication range is “Local”, overlapping contents are detected in the same operation area 700, and the contents to be deleted are determined. If the deduplication range is “Global” on the other hand, overlapping contents are detected in not only the operation area 700 but also a different operation area 700, and the contents to be deleted are determined. The determination method is only an example, and the determination method is not limited to the aforesaid method including a method that compares the data of contents specifically.

After the contents to be deleted are determined, the representative CPU 210 refers to the mapping management table 237 and identifies the archive node 200 that holds the contents to be deleted (which will be called deletion node 200) and transmits a request for deleting the contents to the deletion node 200 (S333).

The CPU 210 of the deletion node 200 (which will be called deletion CPU 210) having received the request for deleting the contents transmits the request for deleting the contents to the storage device 300 connecting to the deletion node 200 (S334). The deletion CPU 210 further transmits the ID of the contents to be deleted along with the deletion request.

The storage device 300 having received the deletion request and the ID of the contents to be deleted deletes the data having the ID of the contents to be deleted from the logical volume 340 (S335) and notifies the deletion node 200 of the completion of the deletion of the contents (S336).

The CPU 210 having received the notification of the completion of the deletion of the contents notifies the representative archive node 200 of the ID of the deleted contents, the own node ID and the completion of the deletion of the contents (S337).

The representative archive node 200 having received the notification registers the ID of the deleted contents and the ID of the deletion node with the mapping management table 237 (S320). This means that the same contents are consolidated to the representative archive node 200. Therefore, the representative archive node 200 establishes a link from the “Node ID” column 237B corresponding to the ID of the deleted contents to the contents having the entity.

The representative archive node 200 updates the mapping management table 237 and then exits the deduplication processing (S305).

The deletion node 200 refers to all archive nodes 200 holding the contents to be deleted.

In this way, in the archive system 1, same contents are consolidated to the representative archive node 200 based on the deduplication range registered with the policy management table 632.

Next, the case (S331: NO) will be described where the contents management processing is the processing of creating an index for search in step S331. The representative CPU 210 performs processing of creating an index as shown in FIG. 17. The index creating processing is performed by the representative CPU 210 based on an index creating program 234.

The representative CPU 210 extracts index information from contents held in the operation area 700 which has the representative archive node 200 (S341). The index information to be extracted may be keyword information extracted from the data of contents or attribute information of a creator who creates the contents, for example.

The representative CPU 210 determines whether the search range of the contents for which an index is created is global or not (S342) based on the policy information transmitted from the management computer 600. If so (S342: YES), the representative CPU 210 refers to the mapping management table 237 and identifies the archive node in a different operation area and holds contents having the same data (S343). The archive node is identified for each contents held by the operation area 700 to which the representative archive node 200.

The representative CPU 210 transmits a request for obtaining the index information to the archive node 200, which is identified in step S343 and is in the different operation area 700 (which will be simply called node 200, hereinafter) (S344).

The CPU 210 of the different node 200 having received the request for obtaining index information extracts the index information from the contents held by the operation area 700 which has the own node (S345) and then transmits the index information to the representative archive node 200 (S346).

The representative CPU 210 transmits the index information extracted in step S341 to the different node 200 holding the contents having the same data (S347).

The CPU 210 of the different node 200 registers the index information from the representative archive node 200 and the index information extracted in step S345 with the index management table 238 (S348) and exits the processing.

In the same manner, the representative CPU 210 registers the index information from the different node 200 and the index information extracted in step S341 with the index management table 238 (S349) and exits the processing.

In this way, if the search range is global, the index information created for contents having the same data can be shared with the archive node 200 in a different operation area (or group). If the search range is “Local”, the index information created for contents having same data within the range of an operation area can be shared among the archive nodes 200 present in the operation area.

The search processing will be described in which the host computer 100 searches arbitrary contents after the end of the processing of creating an index for the arbitrary contents as described above.

The search processing is performed by the representative CPU 210 based on the search program 235.

The host computer 100 transmits a search request to the representative archive node 200 (S401). The search request contains keyword information, for example, for detecting the contents desired by the host computer 100.

The representative CPU 210 detects the contents satisfying a requirement in the received search request based on the index management table 236 (S402).

The representative CPU 210 transmits the detected contents to the host computer 100 and exits the processing.

### [2] Advantages of This Embodiment

As described above, according to this embodiment, each archive node can grasp a site and the location of archive nodes on the site and can perform contents management processing (including copy, deduplication, search index creation and search processing) under an environment where archive nodes included in one archive system are scattered over two or more remote sites.

### [3] Other Embodiments

Having described that the group management table 631, policy management table 632, configuration management program and policy management program 634 are saved in the hard drive 630 of the management computer 600, they may be saved in the hard drive 230 of an archive node 200. In this case, the processing to be performed by the management computer 600 as described above is performed by the representative archive node 200 or another archive node 200.

What is claimed is:

1. An archive system that performs processing on arbitrary contents, the system comprising:
a grouping section that groups multiple archive nodes included in a cluster;
a policy section that defines a requirement for performing processing on the arbitrary contents; and
a control section that determines a group for performing processing on the arbitrary contents based on the group information about the definition of the grouping of the multiple archive nodes and the requirement and controls to perform the processing by the determined group.

2. The archive system according to claim 1, wherein the control section controls the determined group to perform processing on the arbitrary contents in order to save the arbitrary contents to one storage device among multiple storage devices connecting to the archive nodes.

3. The archive system according to claim 2, wherein the grouping section groups one or more archive nodes placed closely or one or more archive nodes sharing one same storage device into one group.

4. The archive system according to claim 1, wherein the processing is one of copy processing of creating a copy of the arbitrary contents, deduplication processing of consolidating the overlapping arbitrary contents into one and searching processing of searching the arbitrary contents.

5. The archive system according to claim 4, wherein the searching processing includes creation processing of creating an index for searching the arbitrary contents.

6. The archive system according to claim 4, wherein the requirement includes a data redundancy and copy range for performing the copy processing.

7. The archive system according to claim 4, wherein the requirement includes a deduplication range for performing the deduplication processing.

8. The archive system according to claim 4, wherein the requirement is a search range for performing the searching processing.

9. A contents management method in an archive system that performs processing on arbitrary contents, the method comprising:
a first step of grouping multiple archive nodes included in a cluster;
a second step of defining a requirement for performing processing on the arbitrary contents; and
a third step of determining a group for performing processing on the arbitrary contents based on the group information about the definition of the grouping of the multiple archive nodes and the requirement and controlling the determined group to perform the processing.

10. The contents management method according to claim 9, wherein the third step controls the determined group to perform processing on the arbitrary contents in order to save the arbitrary contents to one storage device among multiple storage devices connecting to the archive nodes.

11. The contents management method according to claim 10, wherein the third step groups one or more archive nodes placed closely or one or more archive nodes sharing one same storage device into one group.

12. The contents management method according to claim 9, wherein the processing is one of copy processing of creating a copy of the arbitrary contents, deduplication processing of consolidating the overlapping arbitrary contents into one and searching processing of searching the arbitrary contents.

13. The contents management system according to claim 12, wherein the searching processing includes creation processing of creating an index for searching the arbitrary contents.

14. The contents management method according to claim 12, wherein the requirement includes a redundancy and copy range for performing the copy processing.

15. The contents management method according to claim 12, wherein the requirement includes a deduplication range for performing the deduplication processing.

16. The contents management method according to Claim 12, wherein the requirement is a search range for performing the searching processing.
